(19) United States
(12) Patent Application Publication
(10) Pub. No.: US 2009/0015163 A1
(43) Pub. Date: Jan. 15, 2009

(54) Method for producing an electrode and gas discharge lamp having an electrode of this type

(75) Inventors: Jurgen Becker, Berlin (DE); Jianping Liu, Guangzhou (CN)

Correspondence Address: OSRAM SYLVANIA INC, 100 ENDICOTT STREET, DANVERS, MA, 01923, US

(73) Assignee: Patent-Treuhand-Gesellschhaft Fur Elektrische Gluhlampen MBH, Munchen (DE)

(21) Appl. No.: 11/886,962

(22) PCT Filed: Mar. 21, 2006
(86) PCT No.: PCT/DE2006/000496

§ 371 Date: Mar. 26, 2008

(30) Foreign Application Priority Data
Mar. 22, 2005 (DE) 10 2005 013 760.1

(51) Int. Cl. H01J 17/04; H01J 9/14

(52) U.S. Cl. 313/631; 445/49

(57) ABSTRACT

The invention relates to a gas discharge lamp having at least one electrode and to a method for producing an electrode. According to the invention, the structure of a section (30) of the electrode (20, 22) is at least partially transformed by means of high-energy radiation, preferably laser radiation.

### TECHNICAL FIELD

The invention relates to a method for producing an electrode in accordance with the precharacterizing clause of patent claim 1 and to a discharge lamp having an electrode of this type.

### PRIOR ART

Electrodes of this type which have been provided with an electrode tip are used, for example, in discharge lamps. The method for producing the electrode substantially comprises the production of an electrode blank using powder metallurgy, a sintering process and the subsequent mechanical deformation of the blank to the desired electrode diameter. The deformation of the blanks takes place, for example, by means of rolling on a multiple roller or by means of hammering on swaging machines. In this case, the diameter of the blank is reduced whilst at the same time the material is lengthened. For electrodes having a relatively small diameter, the blank diameter is reduced further from approximately 4 mm by means of a drawing process. It has been shown that drawing to thin diameters causes a longitudinally directed fiber structure and, as a result, extreme damage to the microstructure within the electrode, since the grain boundary structures run parallel to the longitudinal axis of the blank, to be precise not only in the region of the electrode shaft but also in the region of the electrode tip. Once the electrode tip has been produced by means of shaping methods known from the general prior art, such as by means of cylindrical grinding or chemical material removal, for example, the grain boundary structure opens out at the angled face of the electrode tip.

In order to improve the grain boundary structure in the region of the electrode tip, it is known from DE 197 38 574 A1 by the applicant to form the electrode tip by means of radial deformation, for example by means of profiled hammer jaws. This solution allows for a grain boundary structure which follows the contour of the electrode tip, since the electrode tip is not produced by means of mechanical or chemical material removal. One disadvantage with electrodes of this type is the fact that the final microstructure and purity of the electrode tip is only achieved during operation of the lamp owing to a recrystallization of the microstructure caused by the effect of temperature of the gas discharge. That is to say that, at the start of operation, electrodes of this type have a long-crystalline, fiber-like microstructure, which results in poor ignition properties and unfavorable arc drawing.

### DESCRIPTION OF THE INVENTION

The invention is based on the object of providing a method for producing an electrode or power supply line and a lamp having an electrode or power supply line of this type, in which an improved operational response is made possible in comparison with conventional solutions.

This object is achieved as regards the method for producing an electrode or power supply line by the features of claims 1 and 4, respectively, and as regards the lamp with an electrode or power supply line of this type by the combination of features in claim 6. Particularly advantageous embodiments of the invention are described in the dependent claims.

In the method according to the invention for producing an electrode, the microstructure of at least one section of the electrode is transformed at least partially by means of high-energy radiation, preferably laser radiation. Owing to the effect of the temperature of the high-energy radiation on this electrode section, the fiber-shaped, long-crystalline microstructure regions are combined to form compact, dense units; in other words, a defined recrystallization of the microstructure of the electrode section takes place. This recrystallization brings about a coarse-crystalline microstructure in the region of this electrode section. As a result, this electrode section has a microstructure and purity which substantially correspond to the operating state of the lamp. The abovementioned electrode section preferably comprises the discharge-side end of the electrode. The abovementioned microstructure of the discharge-side end of the electrode thereby remains stable during operation of the lamp and good ignition properties as well as good arc drawing are ensured. As a result, the electrode tip according to the invention makes possible an optimum ignition response and good arc formation as early as at the start of the life of the lamp in comparison with the prior art in accordance with EP 0 858 098 B1. Furthermore, a high purity of the electrode is achieved owing to the effect of the temperature.

Preferably, the crystal microstructure is transformed continuously. As a result, a defined, coarse-grained microstructure surface of the electrode section is present even after a relatively long period of operation of the discharge lamp.

In the method according to the invention for producing a power supply line, the microstructure of at least one section of the power supply line is transformed at least partially by means of high-energy radiation, preferably laser radiation. For example, a surface section of the power supply line is treated by means of the high-energy radiation in order to vaporize impurities adhering to the surface, for example, or in order to smooth the surface of the power supply line or in order to transform the crystal microstructure of the power supply line at its surface and, as a result, to improve the so-called glass-sealing response of the power supply line, i.e. the adhesion of the power supply line to the glass of the lamp vessel surrounding it and therefore to reduce the risk of the formation of cracks in the lamp vessel owing to the different coefficients of thermal expansion of the glass material and the material of the power supply line. The power supply line is preferably in the form of a wire consisting of molybdenum, tungsten or an alloy of molybdenum or tungsten.

The discharge lamp according to the invention has at least one electrode and at least one power supply line, the microstructure of at least one section of the electrode or of the power supply line being transformed at least partially by means of high-energy radiation, preferably laser radiation.

It has proven to be particularly advantageous if an electrode section has a microstructure which substantially corresponds to the operating state of the discharge lamp.

In accordance with a preferred exemplary embodiment of the invention, this electrode section has a coarse-crystalline microstructure.

Preferably, this electrode section has a purity which substantially corresponds to the operating state of the lamp. As a result, blackening in the discharge vessel is reduced to a minimum and the life of the discharge lamp is substantially lengthened.

In an exemplary embodiment according to the invention, this electrode section is produced by means of high-energy radiation, preferably laser radiation.

The abovementioned electrode section is preferably the discharge-side end of the electrode. The invention is preferably used on bar-shaped tungsten electrodes, in particular for high-pressure discharge lamps.

### BRIEF DESCRIPTION OF THE DRAWINGS

The invention will be explained in more detail below with reference to a preferred exemplary embodiment. In the drawings:

FIG. 1 shows a schematic illustration of a discharge lamp according to the invention, and

FIG. 2 shows an enlarged illustration of an electrode from FIG. 1.

### PREFERRED EMBODIMENTS OF THE INVENTION

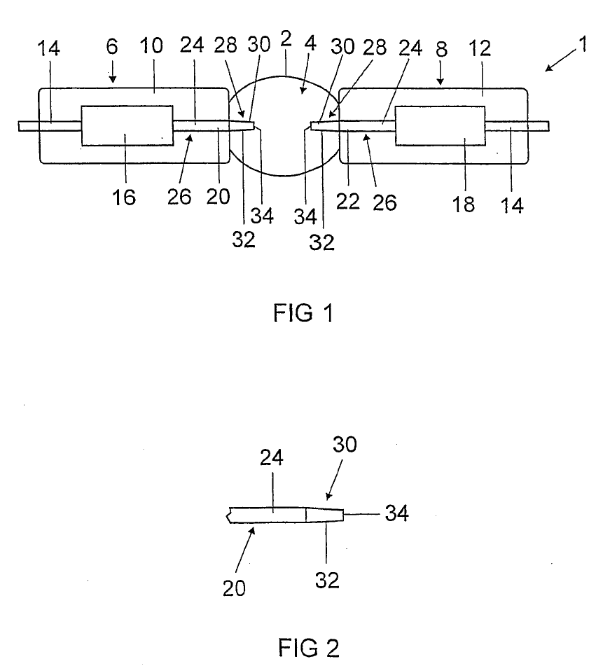

The exemplary embodiment of the invention shown in FIG. 1 is a high-pressure discharge lamp 1, as is used, for example, in vehicle headlamps or projectors. It has a discharge vessel 2 consisting of quartz glass and having an interior 4 and two diametrically arranged, sealed-off end sections 6, 8 which are in the form of glass fuse seals 10, 12 and which each have a power supply line 14, which are welded to approximately rectangular molybdenum foils 16, 18 which are embedded in a gas-tight manner into the glass fuse seals 10, 12 of the discharge lamp 1. Two diametrically arranged, for example pin-shaped electrodes 20, 22 consisting of tungsten doped with ThO₂, which are each welded to one of the molybdenum foils 16, 18 and between which a gas discharge is formed during lamp operation, protrude into the interior 4. An ionizable filling is enclosed in the interior 4 of the discharge vessel 2 which comprises a high-purity xenon gas and a plurality of metal halides. The electrodes 20, 22 each have a first end section 26, which is in the form of an electrode shaft 24 and is embedded in the glass fuse seal 10 or 12. The electrodes 20, 22 are provided with an electrode tip 30 at a second end section 28. The microstructure of the electrode tips 30 is transformed at least partially by means of high-energy radiation. In the exemplary embodiment shown, the high-energy radiation is introduced into the electrode tips 30 by means of lasers. Owing to the effect of the temperature of the laser radiation on the electrode tip 30, the fiber-shaped, long-crystalline microstructure regions are combined to form compact, dense units; in other words a defined recrystallization of the microstructure of the electrode tip 30 takes place. The recrystallization brings about a relatively coarse-crystalline microstructure in the region of the electrode tip 30. As a result, this electrode tip has a microstructure and a purity which substantially correspond to the operating state of the discharge lamp 1. This microstructure of the electrode tip 30 remains stable during operation of the lamp 1 and has good ignition properties as well as advantageous arc drawing. The electrode tip 30 according to the invention makes possible an optimum ignition response and good arc formation as early as at the start of lamp life in comparison with the prior art in accordance with EP 0 858 098 B1. Furthermore, a high purity of the electrodes 20, 22 is achieved owing to the effect of the temperature of the laser radiation.

As shown in FIG. 2, which shows an enlarged illustration of the electrode 20 from FIG. 1, the cylindrical electrode shaft 24 tapers in the form of a truncated cone to the electrode tip 30, whose cone envelope surface 32 opens out on the discharge side into an approximately circular end face 34. As a result, good arc drawing of the discharge lamp 1 is achieved. The electrode tip 30 is produced by means of the laser radiation during the transformation of the microstructure and has the microstructure explained in FIG. 1.

The electrode 20, 22 according to the invention is not restricted to the described shaping of the electrode tip 30 by means of laser radiation; instead the electrode tip 30 can be given any desired geometric forms by means of any deformation technique known from the general prior art, in particular by means of grinding, etching, hammering or the like. In addition, the discharge-side end 30 of the electrodes 20, 22 can also be designed to be thicker instead of tapered. Furthermore, the transformation of the microstructure of the electrode section 30 according to the invention can take place prior to or after welding of the electrode 20, 22 to the molybdenum foil 16, 18.

The invention discloses a lamp 1 having at least one electrode 20, 22, which has an electrode shaft 24 and a discharge-side electrode end 30, as well as a method for producing an electrode 20, 22 of this type. According to the invention, the microstructure of a section of the electrodes is transformed at least partially by means of high-energy radiation, preferably laser radiation.

### LIST OF REFERENCE SYMBOLS

1 Lamp
2 Discharge vessel
4 Interior
6 End section
8 End section
10 Glass fuse seal
12 Glass fuse seal
14 Power supply line
16 Molybdenum foil
18 Molybdenum foil
20 Electrode
22 Electrode
24 Electrode shaft
26 End section
28 End section
30 Electrode tip
32 Cone envelope surface
34 End face

1. A method for producing an electrode (20, 22) for a discharge lamp, characterized in that the microstructure of at least one section (30) of the electrode (20, 22) is transformed at least partially by means of high-energy radiation, preferably laser radiation.

2. The method as claimed in claim 1, the microstructure being transformed continuously.

3. The method as claimed in claim 1, characterized in that the section is one end (30) of the electrode (20, 22).

4. A method for producing a power supply line (14) of a discharge lamp, characterized in that the microstructure of at least one section of the power supply line (14) is transformed at least partially by means of high-energy radiation, preferably laser radiation.

5. The method as claimed in claim 4, characterized in that the section is a surface section of the power supply line (14).

6. A discharge lamp having at least one electrode (20, 22) and at least one power supply line (14), characterized in that the microstructure of at least one section (30) of the electrode (20, 22) and/or of the power supply line (14) is transformed at least partially by means of high-energy radiation, preferably laser radiation.

7. The discharge lamp as claimed in claim 6, the section (30) having a microstructure which substantially corresponds to the operating state.

8. The discharge lamp as claimed in claim 6, the section (30) having a coarse-crystalline microstructure.

9. The discharge lamp as claimed in claim 6, the section (30) having a purity which substantially corresponds to the operating state of the lamp (1).

10. The discharge lamp as claimed in claim 6, the section (30) being produced by means of high-energy radiation, preferably laser radiation.

11. The discharge lamp as claimed in claim 6, the section being the discharge-side end (30) of the electrode (20, 22).

12. The discharge lamp as claimed in claim 6, the electrode (20, 22) being in the form of a bar-shaped tungsten electrode.

13. The discharge lamp as claimed in claim 6, the section being a surface section of the power supply line (14).

14. The discharge lamp as claimed in claim 7, the section (30) having a purity which substantially corresponds to the operating state of the lamp (1).

15. The discharge lamp as claimed in claim 8, the section (30) having a purity which substantially corresponds to the operating state of the lamp (1).

16. The discharge lamp as claimed in claim 7, the section (30) being produced by means of high-energy radiation, preferably laser radiation.

17. The discharge lamp as claimed in claim 8, the section (30) being produced by means of high-energy radiation, preferably laser radiation.

18. The discharge lamp as claimed in claim 9, the section (30) being produced by means of high-energy radiation, preferably laser radiation.

19. The discharge lamp as claimed in claim 7, the section being the discharge-side end (30) of the electrode (20, 22).

20. The discharge lamp as claimed in claim 8, the section being the discharge-side end (30) of the electrode (20, 22).
